(19) United States
(12) Patent Application Publication
(10) Pub. No.: US 2023/0062755 A1
(43) Pub. Date: Mar. 2, 2023

(54) Storage System for Fishing Related Accessories

(71) Applicant: Jay Riley, Attleboro, MA (US)

(72) Inventor: Jay Riley, Attleboro, MA (US)

(21) Appl. No.: 17/492,971

(22) Filed: Oct. 4, 2021

Related U.S. Application Data
(60) Provisional application No. 63/238,413, filed on Aug. 30, 2021.

(51) Int. Cl. A01K 97/06

(52) U.S. Cl. CPC A01K 97/06

(57) ABSTRACT

A system for storing fishing related accessories and equipment. The storage system is configured to retain and secure the fishing related accessories and equipment in close proximity to an angler while fishing for use on demand. A cylindrical body having a center bore opens to receive and encapsulate a railing or other structural member of a boat or dock and is then secured in place via a plurality of cinch straps. Transition members may be used to connect fishing equipment or equipment holders to the straps. Retractable clips can also be used to connect fishing equipment or equipment holders to the straps. Fishing tools can be fixedly or retractable clipped to the cylindrical body for easy manipulation without fear of dropping the tools in the water.

### CROSS-REFERENCE TO RELATED APPLICATION

The present application claims priority to, and the benefit of, U.S. Provisional Application No. 63/238,413, which was filed on Aug. 30, 2021 and is incorporated herein by reference in its entirety.

### FIELD OF THE INVENTION

The present invention generally relates to an organizer for fishing equipment, and more specifically to a storage system for keeping fishing related accessories accessible and organized. Accordingly, the present specification makes specific reference thereto. However, it is to be appreciated that aspects of the present invention are also equally amenable to other like applications, devices, and methods of manufacture.

### BACKGROUND

Fishing is a recreational or commercial activity where individuals try to catch fish or other aquatic creatures. Angling is a type of fishing where the individual used a fishhook or “angle” to fish. The fishhook is attached to a fishing line which is typically manipulated with a fishing rod or pole. Live bait may be attached to the fishhook or a hooked lure that simulates bait is cast into the water and is used in an attempt to entice fish to bite. Angling is an extremely popular recreational activity.

In addition to the main fishing gear, such as a rod and reel, additional equipment known as fishing tackle is used while fishing. Almost any equipment or gear used for fishing can be considered fishing tackle. In general fishing tackle refers to the physical equipment that is used when fishing. Smaller fishing tackle, such as fishing line, lures, hooks, bobbers, and weights is often retained in a tackle box. In addition to traditional fishing tackle, anglers employ a wide variety of other equipment while fishing, including fish holding containers, bait buckets, cleaning tools, beverage containers, cell phones, and the like.

Storing fishing tools and related accessories while fishing on a boat can be a difficult task. Tackle boxes can be unorganized and may leave items and accessories susceptible to damage. Additionally, they are often closed to prevent spilling contents due to boat movement or accidental contact. Convenient and safe access to tools and other items is necessary for an enjoyable fishing experience. Equipment that is not safely and readily accessible is often simply not used when needed due to the inconvenience of access.

Accordingly, there is a great need for a way to store fishing equipment while fishing safely and conveniently. There is also a need for a way for a way to access fishing equipment on a boat without the danger of a container spilling contents due to boat movement. Similarly, there is a need for a system that keeps tools in an easily accessible position while fishing. Further, there is a need for a storage system that prevents damage to fishing equipment while fishing and also protects a fishing rod during storage,

In this manner, the improved storage system of the present invention accomplishes all of the forgoing objectives, thereby providing an easy solution for safely and conveniently storing fishing equipment for immediate use. A primary feature of the present invention is a system that can be secured directly to a boat where it is needed so that the user can immediately access the equipment needed. The present invention allows anglers to secure items to the storage system and keep them in an easily accessible position while fishing. Finally, the improved fishing equipment storage apparatus of the present invention is capable of keeping the equipment safe during use and protecting fishing equipment when not in use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a storage system for fishing related accessories and equipment. The storage system holds and secures the fishing related accessories and equipment near the angler for use as needed. The storage system is configured to retain anything needed while fishing, such as, but not limited to bait buckets, cleaning towels, pliers, fishing tackle, beverage containers, smart phones, portable electronic devices, or food containers.

The storage system comprises a cylindrical body and a plurality of strap members. The cylindrical body comprises a pair of ends, a center bore, and a horizontal slit. The center bore runs through the cylindrical body between the pair of ends. The horizontal slit extends along the cylindrical body between the pair of ends penetrating from an external surface into the center bore. The cylindrical body is flexible and compressible. The center bore is configured to encapsulate a rail or bar, such as a railing. To encapsulate the rail or bar, the horizontal slit is spread apart creating a temporary opening exposing the center bore. The rail or bar is passed through the opening to rest within the center bore and the horizontal slit is relaxed to close up so that the rail or bar is encapsulated.

The plurality of strap members are configured to encircle the cylindrical body. Each strap member is an adjustable strap comprising an adjustable closure mechanism and an attachment element. Each adjustable closure mechanism is used to tighten each respective strap around the cylindrical body to secure the cylindrical body around the the rail. Each attachment element may be used to secure fishing related accessories and equipment to the cylindrical body.

The storage system may further comprise a plurality of fishing accessory holders. The plurality of fishing accessory holders are configured to retain fishing related accessories and equipment. The plurality of fishing accessory holders may be customized to fit specific fishing related accessories and equipment, such as, but not limited to fishing tackle, beverage containers, smart phones, portable electronic devices, or food containers. The plurality of fishing accessory holders can attach directly to the attachment elements of the adjustable straps.

The storage system may further comprise a plurality of transition members. The plurality of transition members may be carabiners, coupling links, D-rings, snap hooks, or other securing attachment hardware. Each transition members is configured to attach to one of the strap members. Each transition member is attachable directly to the respective attachment element. Fishing related accessories and equipment may be directly connected to the cylindrical body by the plurality of transition members. Additionally, any of the plurality of fishing accessory holders may be directly connected to the cylindrical body by the plurality of transition members.

The storage system may further comprise a plurality of retracting members. The plurality of retracting members may be retractable clips. Each retracting member is configured to attach to one of the strap members. Each retracting member is attachable directly to the respective attachment element. Additionally, each retracting member is attachable to the respective attachment element via one of the transition members. Each retracting member is also configured to attach to either one of the plurality of fishing accessory holders or directly to fishing related accessories and equipment, such as, but not limited to bait buckets, cleaning towels, fishing tackle, or pliers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a storage system of the present invention for fishing related accessories in accordance with the disclosed architecture.

FIG. 2 illustrates a perspective view of one potential embodiment of a cylindrical body of the storage system of the present invention for fishing related accessories in accordance with the disclosed architecture.

FIG. 3 illustrates an end view of one potential embodiment of the cylindrical body of the storage system of the present invention for fishing related accessories in accordance with the disclosed architecture.

FIG. 4 illustrates an end view of one potential embodiment of a first half and a second half of the cylindrical body of the storage system of the present invention for fishing related accessories in accordance with the disclosed architecture.

FIG. 5 illustrates an end view of one potential embodiment of the cylindrical body of the storage system of the present invention for fishing related accessories in an open position in accordance with the disclosed architecture.

FIG. 6 illustrates a perspective view of one potential embodiment of the storage system of the present invention for fishing related accessories in accordance with the disclosed architecture.

FIG. 7 illustrates a perspective view of one potential embodiment of the storage system of the present invention for fishing related accessories in accordance with the disclosed architecture.

FIG. 8 illustrates a perspective view of one potential embodiment of the storage system of the present invention for fishing related accessories attached to a boat in accordance with the disclosed architecture.

FIG. 9 illustrates a perspective view of one potential embodiment of a retracting member of the storage system of the present invention for fishing related accessories attached to a boat in accordance with the disclosed architecture.

FIG. 10 illustrates a perspective view of one potential embodiment of the storage system of the present invention for fishing related accessories partially encapsulating a fishing rod in accordance with the disclosed architecture.

FIG. 11 illustrates a perspective view of one potential embodiment of the storage system of the present invention for fishing related accessories in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, provides users with a tube-like storage mechanism for fishing tools and accessories. The storage apparatus can attach directly to a boat rail via hook and loop fastener strap system and includes several eyelets and retractable clips to hold tools and accessories. The storage device allows users to secure items to each clip and keep them in an easily accessible position while fishing. The storage device enables users to simply slide the tube over a fishing rod for storage once an excursion is finished. The present invention offers a convenient way for anglers to store fishhook pliers, a towel, a cup holder, hooks and weights, bait, and the like.

A storage system is comprised of a tubular shape body with several hook and loop fastener straps, eyelets, and retractable clips is configured to retain and secure the fishing related accessories and equipment in close proximity to an angler while fishing for use on demand. The tube shaped body can be strapped directly to a boat railing or other structural member of a boat or dock via the hook and loop fastener straps. Each strap can have an eyelet and retractable clip to hold desired tools and accessories like bait buckets, fish towels, fishhook pliers, a cup or snack holder, hooks and weights, and the like. Users can easily store and access their fishing related items and equipment while fishing without fear of dropping the tools in the water. When finished, the tubular shape body can be at least partially slid over a fishing rod for storage.

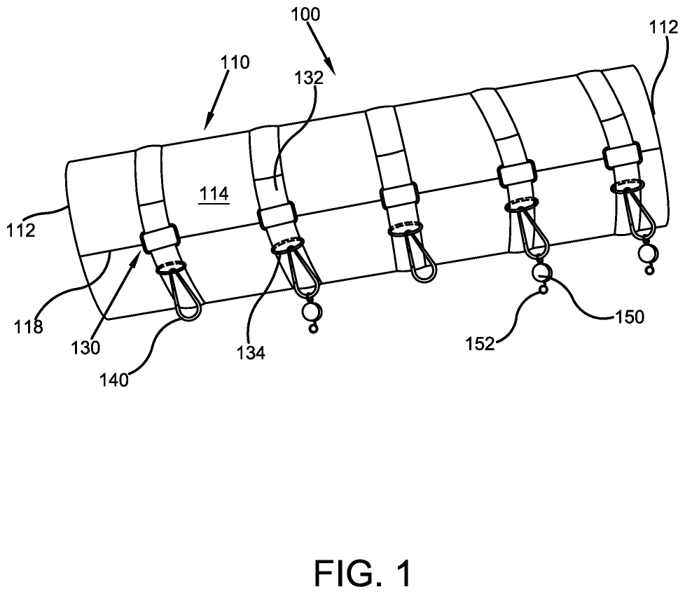

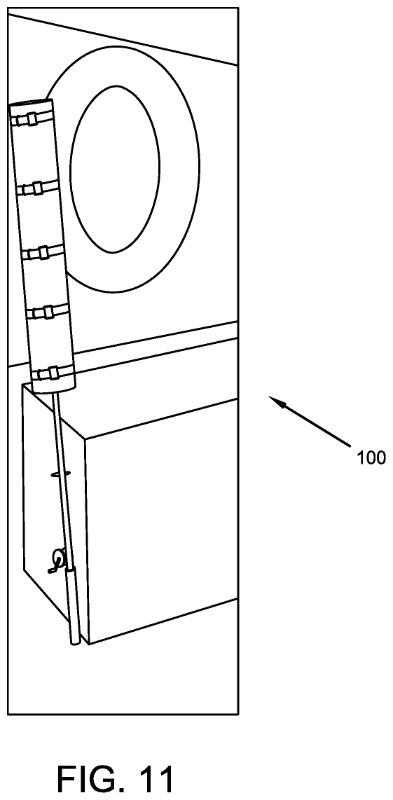

Referring initially to the drawings, FIGS. 1-11 illustrate a storage system 100 for fishing related accessories. The storage system 100 holds and secures the fishing related accessories and equipment near the angler for use as needed. The storage system 100 is configured to retain anything needed while fishing, such as, but not limited to bait buckets, cleaning towels, pliers, fishing tackle, beverage containers, smart phones, portable electronic devices, or food containers. As illustrated in FIG. 11, the storage system 100 may also be used to protect a fishing rod when not in use.

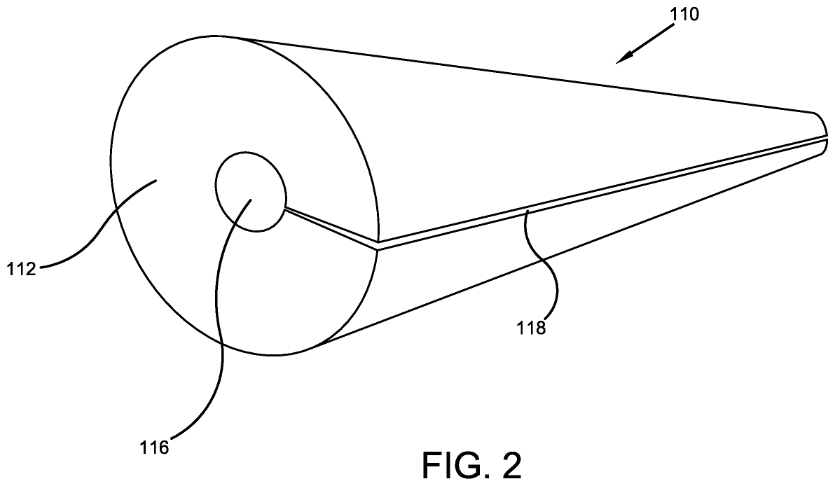

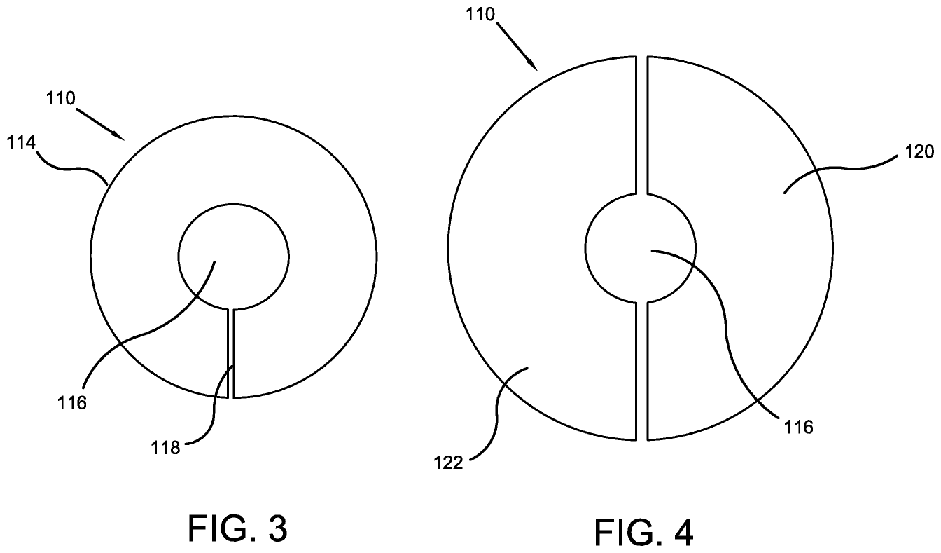

As illustrated in FIG. 1, the storage system 100 comprises a cylindrical body 110 and a plurality of strap members 130. As further illustrated in FIGS. 2-3, the cylindrical body 110 comprises a pair of ends 112, a center bore 116, and a horizontal slit 118. The center bore 116 runs through the cylindrical body 110 between the pair of ends 112. The horizontal slit 118 extends along the cylindrical body 110 between the pair of ends 112 penetrating from an external surface 114 of the cylindrical body 110 into the center bore 116. Alternatively, as illustrated in FIG. 4, the cylindrical body 110 may further comprise a first half 120 and a second half 122 that sandwich together.

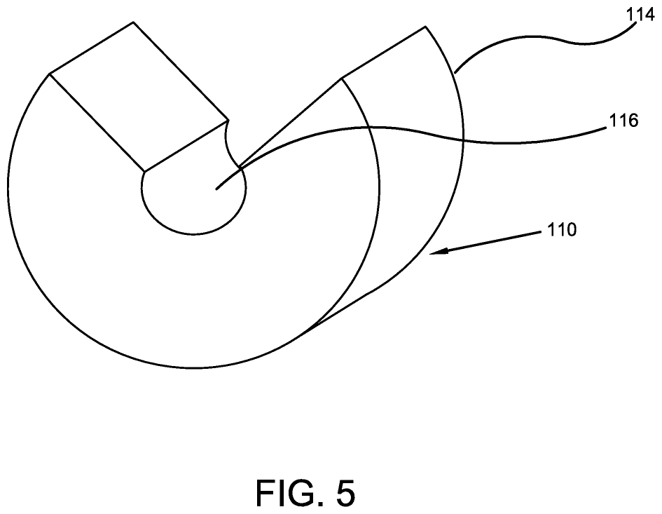

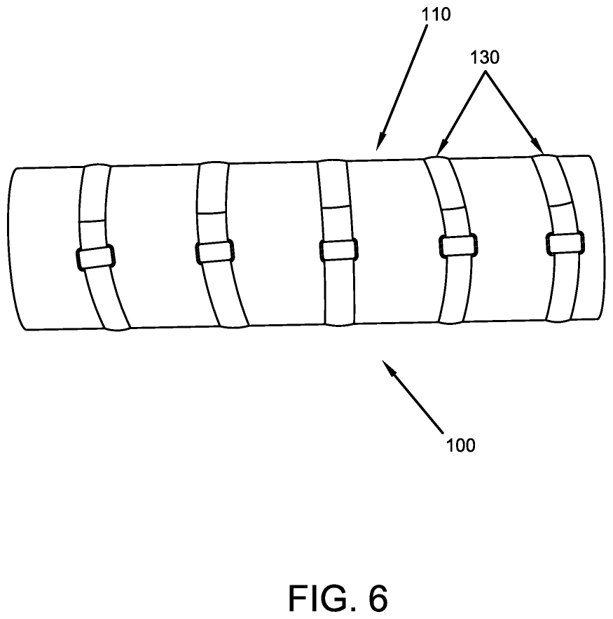

The cylindrical body 110 is generally flexible and compressible. The cylindrical body 110 is typically manufactured from a buoyant plastic, a memory material, or a compressed or closed cell foam, such as a foam noodle. The cylindrical body 110 may also be reflective, luminescent, or fluorescent. The center bore 116 is sized and configured to encapsulate a rail or bar, such as a railing on a boat or a dock. To encapsulate the rail or bar, the horizontal slit 118 is spread apart creating a temporary wider opening exposing the center bore 116 as illustrated in FIG. 5. The rail or bar is passed through the opened horizontal slit 118 to rest within the center bore 116. The horizontal slit 118 has a memory so that once in place, the horizontal slit 118 is relaxed to close up so that the rail or bar is encapsulated within the cylindrical body 110. In one embodiment, the cylindrical body 110 is approximately 24 inches in length, approximately 3.5 inches in diameter, with an approximately one inch in diameter center bore, although the cylindrical body 110 may be of any dimension as desired.

As illustrated in FIGS. 1 and 6, the plurality of strap members 130 are configured to be positioned around and substantially encircle the cylindrical body 110. Each strap member 130 is typically an adjustable strap, such as a cinch strap, an elastic strap, a nylon strap, or the like. Each strap member 130 comprises an adjustable closure mechanism 132 and an attachment element 134. Each adjustable closure mechanism 132 is used to tighten each respective strap 130 around the cylindrical body 110 to secure the cylindrical body 110 around the rail or bar. Each adjustable closure mechanism 132 may be a hook and loop fastening system, a buckle, a snap, a mechanical fastener, or a magnetic closure as illustrated in FIG. 10. Each attachment element 134 may be used to secure fishing related accessories and equipment to the cylindrical body 110. Each attachment element 134 may be a metal or plastic ring, loop, eyelet, ringlet, or the like. In one embodiment, each cinch strap 130 is attached to a back flat side of a “D” ring through an inner core. There are no glues or adhesives necessary. This unique design allows the cylindrical body 110 to attach and lock down with no lose parts that could fall off of the cylindrical body 110. The rounded part of the D ring is exposed through a front side of the cylindrical body 110. These exposed rings are used to safely attach fishing accessories.

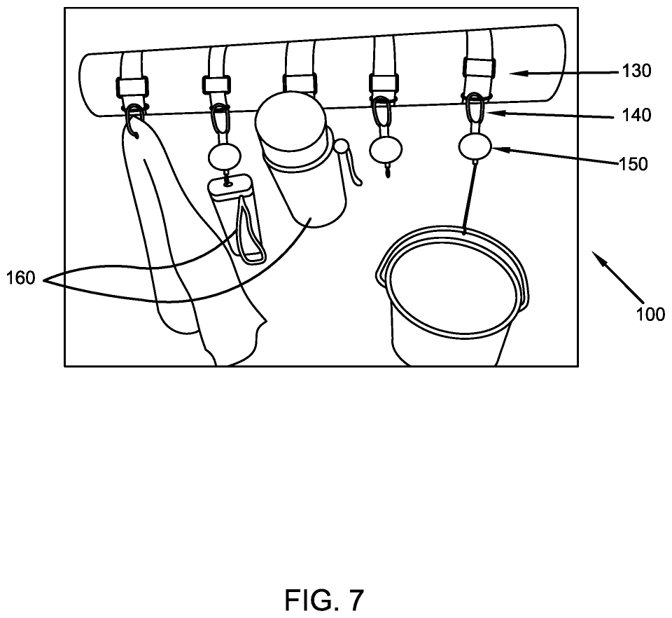

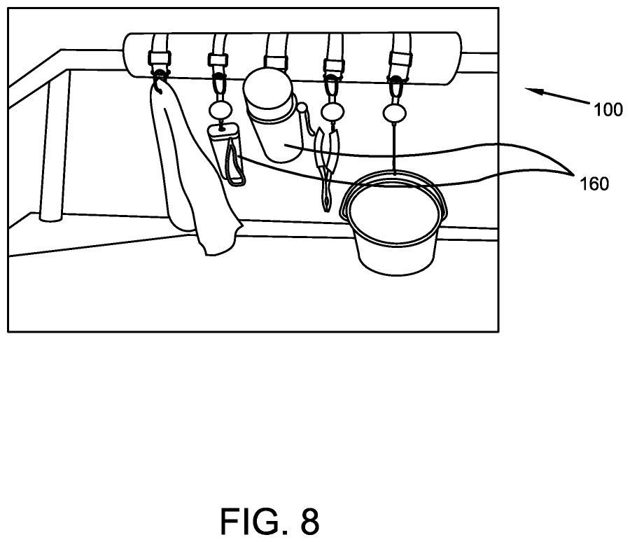

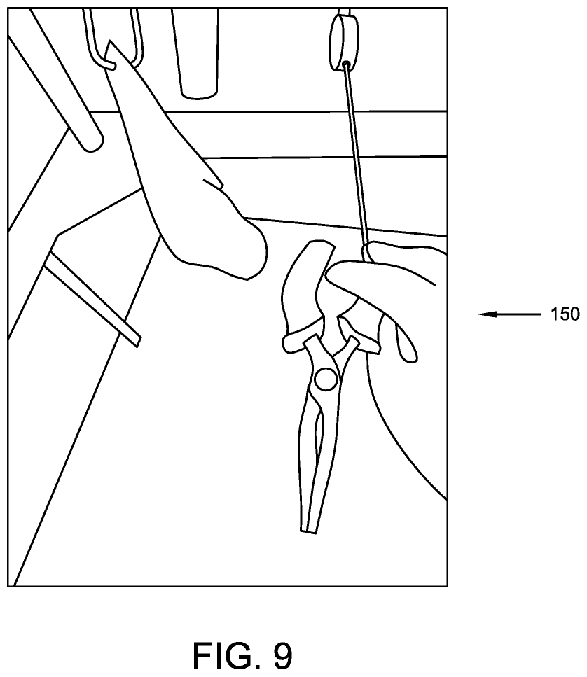

As illustrated in FIGS. 7 and 8, the storage system 100 may further comprise a plurality of fishing accessory holders 160. The plurality of fishing accessory holders 160 are configured to retain fishing related accessories and equipment. The plurality of fishing accessory holders 160 may be customized to fit specific fishing related accessories and equipment, such as, but not limited to fishing tackle, beverage containers, smart phones, portable electronic devices, or food containers. The plurality of fishing accessory holders 160 can attach directly to the attachment elements 134 of the plurality of strap members 130. The plurality of fishing accessory holders 160 can be closable, adjustable, water-tight, or water-proof as needed.

The storage system 100 may further comprise a plurality of transition members 140. The plurality of transition members 140 may be carabiners, coupling links, D-rings, snap hooks, or other similar securing attachment hardware. Each transition member 140 is configured to attach or clip to one of the plurality of strap members 130. Each transition members 140 is attachable directly to the respective attachment element 124 of the respective strap member 130. Fishing related accessories and equipment may then be directly connected to the cylindrical body 110 via the plurality of transition members 130. Additionally, any of the plurality of fishing accessory holders 160 may be directly connected to the cylindrical body 110 by the plurality of transition members 140.

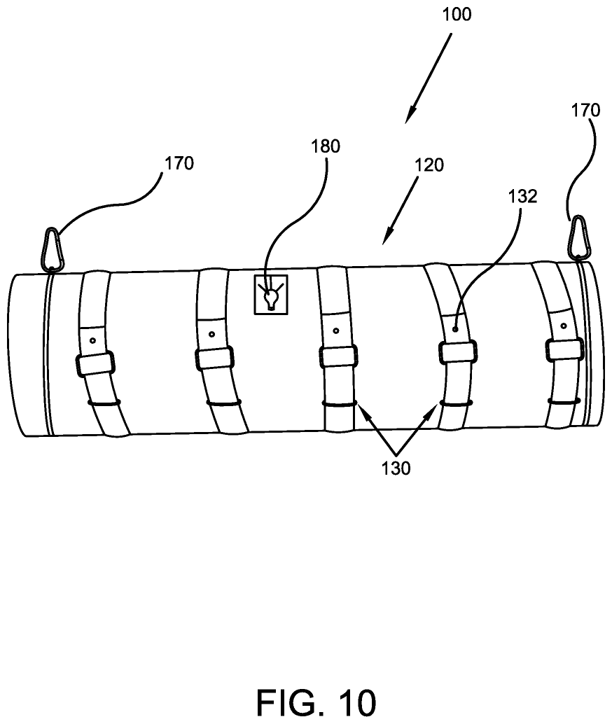

The storage system 100 may further comprise a plurality of retracting members 150. The plurality of retracting members 150 may be retractable clips, reels, or cords. Each retracting member 150 is configured to attach to one of the plurality of strap members 130. Each retracting member 150 is attachable directly to the respective attachment element 134 of the respective strap member 130. Additionally, each retracting member 150 is attachable to the respective attachment element 134 via one of the transition members 140. Each retracting member 150 comprises an attachment point 152 configured to attach to and secure either one of the plurality of fishing accessory holders 160 or directly to fishing related accessories and equipment, such as, but not limited to bait buckets, cleaning towels, snack holders, drink holders, fishing tackle, or pliers as further illustrated in FIG. 9. The plurality of retracting members 150 allow the user greater flexibility in using anything attached to it without the fear of it falling in the water.

As illustrated in FIG. 10, the storage system 100 may further comprise an alternative mounting component 170. The alternative mounting component 170 may be clips, ties, carabiners, or other mechanical fasteners allowing the user to secure or mount the storage system 100 where there is no rail or bar. The alternative mounting component 170 could simply attach directly to any anchor point. The storage system 100 may further comprise a lighting element 180. The lighting element 180 may be a battery operated light attached directly to or embedded within the cylindrical body 110.

Notwithstanding the forgoing, the storage system for fishing related accessories 100 can be any suitable size, shape, and configuration as is known in the art without affecting the overall concept of the invention, provided that it accomplishes the above stated objectives. One of ordinary skill in the art will appreciate that the shape and size of the storage system for fishing related accessories 100 and its various components, as show in the FIGS. are for illustrative purposes only, and that many other shapes and sizes of the storage system for fishing related accessories 100 are well within the scope of the present disclosure. Although dimensions of the storage system for fishing related accessories 100 and its components (i.e., length, width, and height) are important design parameters for good performance, the storage system for fishing related accessories 100 and its various components may be any shape or size that ensures optimal performance during use and/or that suits user need and/or preference. As such, the storage system for fishing related accessories 100 may be comprised of sizing/shaping that is appropriate and specific in regard to whatever the storage system for fishing related accessories 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A storage system for fishing related accessories comprising:
a cylindrical body comprising a center bore and a horizontal slit extending between a pair of ends and into the center bore of the cylindrical body; and
a plurality of strap members configured to encircle the cylindrical body, each strap member comprising an adjustable closure mechanism and an attachment element.

2. The storage system for fishing related accessories of claim 1, wherein the cylindrical body is buoyant.

3. The storage system for fishing related accessories of claim 1, wherein the cylindrical body is flexible.

4. The storage system for fishing related accessories of claim 1, wherein the horizontal slit is configured to spread apart to expose the center bore.

5. The storage system for fishing related accessories of claim 1, wherein the horizontal slit has a memory.

6. The storage system for fishing related accessories of claim 1, wherein the plurality of strap members are cinch straps.

7. The storage system for fishing related accessories of claim 1, wherein each adjustable closure mechanism is a hook and loop fastening system.

8. The storage system for fishing related accessories of claim 1, wherein each adjustable closure mechanism is magnetic.

9. The storage system for fishing related accessories of claim 1 further comprising a plurality of transition members, each attachable to one of the attachment elements of the plurality of strap members.

10. The storage system for fishing related accessories of claim 9, wherein the plurality of transition members are carabiners.

11. The storage system for fishing related accessories of claim 1 further comprising a plurality of retracting members, each attachable to one of the attachment elements of the plurality of strap members.

12. The storage system for fishing related accessories of claim 11, wherein the plurality of retracting members are retractable clips.

13. The storage system for fishing related accessories of claim 1 further comprising a plurality of fishing accessory holders, each attachable to one of the attachment elements of the plurality of strap members.

14. A storage system for fishing related accessories comprising:
a cylindrical body comprising a center bore and a horizontal slit extending between a pair of ends and into the center bore of the cylindrical body;
a plurality of strap members configured to encircle the cylindrical body, each strap member comprising an adjustable closure mechanism and an attachment element;
a plurality of retracting members, each attachable to one of the attachment elements of the plurality of strap members; and
a plurality of fishing accessory holders, each attachable to one of the attachment elements of the plurality of strap members or to one of the plurality of retracting members.

15. The storage system for fishing related accessories of claim 14, wherein the cylindrical body is buoyant and flexible.

16. The storage system for fishing related accessories of claim 14, wherein the horizontal slit is configured to spread apart to expose the center bore then contract.

17. The storage system for fishing related accessories of claim 14, wherein the plurality of strap members are hook and loop cinch straps.

18. The storage system for fishing related accessories of claim 14, wherein the plurality of strap members are nylon.

19. The storage system for fishing related accessories of claim 14, wherein the plurality of retracting members are retractable clips configured to retain fishing related accessories or the plurality of fishing accessory holders.

20. A storage system for fishing related accessories comprising:
a cylindrical body comprising a center bore and a horizontal slit extending between a pair of ends and into the center bore of the cylindrical body;
a plurality of strap members configured to encircle the cylindrical body, each strap member comprising an adjustable closure mechanism and an attachment element;
a plurality of transition members, each attachable to one of the attachment elements of the plurality of strap members.
a plurality of retracting members, each attachable to one of the attachment elements of the plurality of strap members or to one of the plurality of transition members; and
a plurality of fishing accessory holders, each attachable to one of the attachment elements of the plurality of strap members, to one of the plurality of transition members, or to one of the plurality of retracting members.
